(19) United States
(12) Patent Application Publication
(10) Pub. No.: US 2006/0155696 A1
(43) Pub. Date: Jul. 13, 2006

(54) METHOD FOR INTELLECTUAL ASSET MANAGEMENT AND ANALYSIS

(76) Inventors: Da-Wei Juang, Taipei County (TW); Chi-Jen Lin, Taipei City (TW); Ming-Che Cheng, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/160,260

(22) Filed: Jun. 16, 2005

(30) Foreign Application Priority Data
Jan. 12, 2005 (TW) 94100809

(51) Int. Cl. G06F 7/00; G06F 17/30

(52) U.S. Cl. 707/4

(57) ABSTRACT

A method for intellectual asset management and analysis is provided, including a method of combining intellectual asset and an expert and artificial intelligence hinting method, wherein the former includes a process of key word combination, a process of self-determined combination and a process of recombination. The process of key word combination includes acquiring a document with key words from an intellectual asset according to a key word and a pre-determined search condition to form a key word document set. The process of self-determined combination includes acquiring a self-determined index document from an intellectual asset according to a self-determined index to form a self-determined index document set. The process of recombination includes reassembling the existing key word document set or the existing self-determined index document set according to a pre-determined sifting condition. The hinting method provides a word related to the key word, acquired in a comparative related word database.

### CROSS-REFERENCE TO RELATED APPLICATION

This application claims the priority benefit of Taiwan application serial no. 94100809, filed on Jan. 12, 2005. All disclosure of the Taiwan application is incorporated herein by reference.

### BACKGROUND OF THE INVENTION

1. Field of the Invention

The present invention relates to a method for intellectual asset management and analysis, and more particularly, to a method for intellectual asset management and analysis suitable for analyzing and managing the patent information, so as to effectively accelerate the work process flow rate, reduce the human error, and accumulate the intellectual asset.

2. Description of the Related Art

Currently, the method for intellectual asset management and analysis is executed manually or by simple computer system. It is mainly implemented by building a database first, and then having users search the knowledge required by their work in the database. During the search operation, before the required information is accessed, an index system or an index file is utilized, as well as the key words, to locate a specific address of the knowledge (called “information search behavior”). However, for an enterprise with abundant internal and external knowledge resources, the user has to repeatedly perform the information search behavior to acquire the complete information required for work. Such information search process occupies users a great amount of time and further consumes their time for analyzing and regenerating information which has more actual productivity.

In addition, when the conventional method for intellectual asset management and analysis is applied to the information having a document number (e.g. patent documents having patent numbers or labels), a basic search is performed on the information in the database according to key words or terms, to obtain an index document. However, to sift through the files represented by the index document would take a long time.

In addition, the conventional concept for information management only focuses on the information sought by the user. However, with the trend of information increasing exponentially, when the user searches the information having the document number in the database using a key word or terms, a lot of undesired data would be generated. Thus, how to delete the undesired data and to store the remaining data have become a key subject in order to save the time in searching and collecting information, such that only the desired data can be acquired by entering proper key word.

Further, the collaboration concept is not incorporated in the conventional method for intellectual asset management and analysis, thus both senior and junior employees have to spend time in searching the information. For seniors, there is no simple facility to share their experiences and information searched during the search process with other users, and there is no facility to record the working process of the seniors, so the opportunity of transferring the intellectual capital into the intellectual asset is missed. For juniors, since they may not have full understanding of their working field, thus they would spend more time in searching the information, and since there is no simple facility for the juniors to acquire the experiences from the seniors, the learning curve for the juniors is more flat and the time frame for the juniors to work independently will be prolonged. Accordingly, from different aspects, the conventional method for intellectual asset management and analysis cannot easily transfer the intellectual capital to the intellectual asset and accumulate the intellectual asset, thus the competitiveness of the enterprise is significantly reduced.

### SUMMARY OF THE INVENTION

Therefore, it is an object of the present invention to provide a method for intellectual asset management and analysis in order to effectively transfer the enterprise's intellectual capital to intellectual asset, so as to further improve the enterprise's competitiveness.

It is another object of the present invention to provide a method of combining intellectual asset in order to effectively transfer the enterprise's intellectual capital to intellectual asset, so as to further improve the enterprise's competitiveness.

It is yet another object of the present invention to provide a self-determined combination process in order to effectively transfer the enterprise's intellectual capital to intellectual asset, so as to further improve the enterprise's competitiveness.

It is still another object of the present invention to provide a recombining process in order to effectively transfer the enterprise's intellectual capital to intellectual asset, so as to further improve the enterprise's competitiveness.

It is still another object of the present invention to provide an expert and artificial intelligence hinting method for providing proper key words for users to select, to help the users acquire the desired information, and save their search time, so as to further improve the enterprise's competitiveness.

The present invention provides a method for intellectual asset management and analysis for accumulating, utilizing, and managing intellectual asset. The method for intellectual asset management and analysis comprises a method of combining intellectual asset and an expert and artificial intelligence hinting method. Wherein, the method of combining intellectual asset comprises steps (a), (b), and (c) as follows. The step (a) comprises inputting a key word, and acquiring at least one key word document from the intellectual asset according to the key word and a predetermined search condition to form a key word document set. The step (b) comprises inputting a self-determined index, and acquiring at least one self-determined index document from the intellectual asset according to the self-determined index to form a self-determined index document set. The step (c) comprises reassembling the existing key word document set or the existing self-determined index document set according to a pre-determined sifting condition. The expert and artificial intelligence hinting method comprises the following steps. First, a key word is inputted. Then, a word related to the key word is acquired from a comparative related word database provided by the expert and artificial intelligence hinting method. Finally, the word is provided to the users for selection.

The present invention provides a method of combining intellectual asset for accumulating, utilizing, and managing intellectual asset. The method of combining intellectual asset comprises steps (a), (b), and (c) as follows. The step (a) comprises inputting a key word, and acquiring at least one key word document from the intellectual asset according to the key word and a predetermined search condition to form a key word document set. The step (b) comprises inputting a self-determined index, and acquiring at least one self-determined index document from an intellectual asset according to the self-determined index to form a self-determined index document set. The step (c) comprises reassembling the existing key word document set or the existing self-determined index document set according to a pre-determined sifting condition.

In accordance with the method for intellectual asset management and analysis and the method of combining intellectual asset provided by the present invention, the step (a) further comprises the following steps. First, the key word document set not matching with a predetermined key word sifting condition is deleted. Then, the remaining key word document set after the deletion is saved.

In accordance with the method for intellectual asset management and analysis and the method of combining intellectual asset provided by the present invention, the step (b) further comprises the following steps. First, the self-determined index document set not matching with a predetermined self-determined sifting condition is deleted. Then, the remaining self-determined index document set after the deletion is saved.

In accordance with the method for intellectual asset management and analysis and the method of combining intellectual asset provided by the present invention, the step (c) further comprises the following steps. First, the key word document set or the self-determined index document set not matching with a predetermined reassemble sifting condition is deleted. Then, the remaining key word document set or the remaining self-determined index document set after the deletion is saved.

In accordance with the method for intellectual asset management and analysis and the method of combining intellectual asset provided by the present invention, the intellectual asset comprises patents.

The method for intellectual asset management and analysis according to the present invention further comprises a project management method, which comprises the following steps. First, a project is defined. Then, a staff suitable for the project are assembled into a virtual team. Finally, the intellectual asset belonging to the project is created by the virtual team.

In accordance with the method for intellectual asset management and analysis provided by the present invention, the expert and artificial intelligence hinting method provides an expert knowledge module and an artificial intelligence module. The expert knowledge module provides an expert related word database, and the artificial intelligence module provides an automatic related word database. The expert related word database is combined with the automatic related word database to form a comparative related word database.

In accordance with the method for intellectual asset management and analysis provided by the present invention, the artificial intelligence module performs the following steps. First, a document or a document set is received. Then, a plurality of terms and phrases in the document or the document set is properly divided into a plurality of words, and the divided words are subsequently reassembled. Then, the importance and correlation of such words are determined. Finally, the words not matching with an artificial intelligence sifting condition are deleted, and the remaining words after the deletion are included into the automatic related word database.

The present invention further provides a self-determined combination process, which comprises the following steps. First, a self-determined index is inputted, and at least one self-determined index document is acquired from the intellectual asset according to the self-determined index to form a self-determined index document set. Then, the self-determined index document set not matching with a predetermined self-determined sifting condition is deleted, and the remaining self-determined index document set after the deletion is saved.

The present invention further provides a recombination process, which comprises the following steps. First, the existing key word document set or the existing self-determined index document set is reassembled according to a pre-determined sifting condition. Next, the key word document set or the self-determined index document set not matching with a predetermined reassemble sifting condition is deleted. Then, the remaining key word document set or the remaining self-determined index document set after the deletion is saved.

The present invention further provides an expert and artificial intelligence hinting method, which comprises the following steps. First, a key word is inputted. Then, a word related to the key word is acquired from a comparative related word database provided by the hinting method. Finally, the word is provided to the user for selection.

The expert and artificial intelligence hinting method described in the embodiment of the present invention further comprises providing an expert knowledge module and an artificial intelligence module. The expert knowledge module provides an expert related word database, and the artificial intelligence module provides an automatic related word database. The expert related word database is combined with the automatic related word database to form a comparative related word database.

In accordance with the expert and artificial intelligence hinting method described in the present invention, the artificial intelligence module performs the following steps. First, a document is received. Then, at least one term or phrase in the document is properly divided into a plurality of words, and the divided words are reassembled. Then, the importance and correlation of these words are determined. Finally, the words not matching with an artificial intelligence sifting condition are deleted, and the remaining words after the deletion are included into the automatic related word database.

The method for intellectual asset management and analysis provided by the present invention comprises a method of combining intellectual asset and an expert and artificial intelligence hinting method, wherein the method of combining intellectual asset includes a step of key word combination, a process of self-determined combination, and a process of recombination. The expert and artificial intelligence hinting method helps the user select appropriate key words or self-determined index, such that the user can acquire the desired data instantly. In addition, by deleting some document set according to the sifting condition, storing and reassembling the remaining document set after the deletion, it is possible to transfer the enterprise's intellectual capital into intellectual asset and keep accumulating the asset, such that the enterprise's competitiveness is effectively enhanced.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 schematically shows a flow chart illustrating a method of combining intellectual asset according to a first embodiment of the present invention.

FIG. 2 schematically shows a flow chart illustrating a process of self-determined combination according to a second embodiment of the present invention.

FIG. 3 schematically shows a flow chart illustrating a process of recombination according to a third embodiment of the present invention.

FIG. 4 schematically shows a flow chart illustrating an expert and artificial intelligence hinting method according to a fourth embodiment of the present invention.

FIG. 5 schematically shows a flow chart illustrating a method for intellectual asset management and analysis according to a fifth embodiment of the present invention.

FIG. 6 schematically shows a system diagram when applying a method for intellectual asset management and analysis according to the fifth embodiment of the present invention.

### DESCRIPTION OF THE EMBODIMENTS

First, terminologies such as “intellectual capital”, “intellectual asset”, and “intellectual property” used in the present invention are defined hereinafter.

“Intellectual capital” is the useful knowledge and experience resources inside or outside the enterprise. In addition to the shared (explicit) knowledge or experiences, the employee's creativity, problem-solving ability, planning and analyzing ability, entrepreneurship are also included.

“Intellectual asset” is the shared (explicit) knowledge or experience resources inside the enterprise, usually saved in the computer system or files in the form of electronic or paper document, and originates from the employees during their office work or originates from outside when employees collect data required for work. In addition, besides the knowledge resources stored in the internal system, other resources acquired from external free or subscription websites accessible to the employees are also considered as the “intellectual asset” in the present invention.

“Intellectual property” is the knowledge resources inside the enterprise duly protected by law, including copyright, patent right, trademark right, business agendas, integrated circuit layout, etc.

### First Embodiment

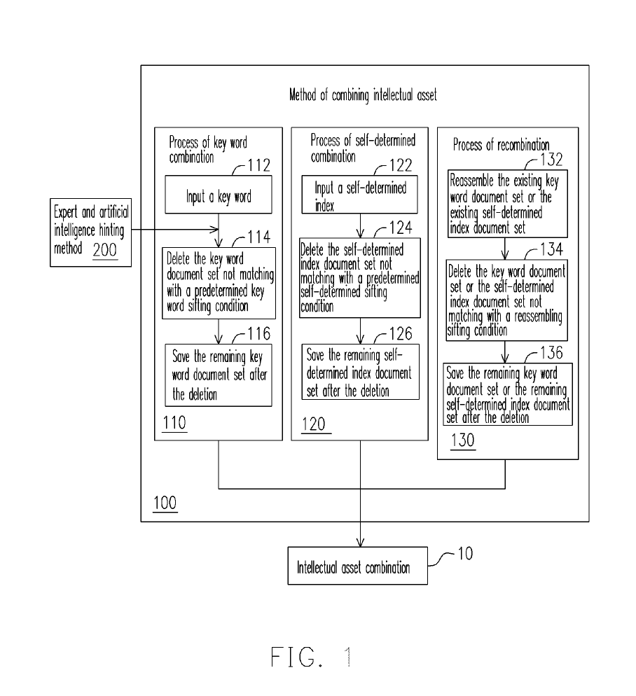

FIG. 1 schematically shows a flow chart illustrating a method of combining intellectual asset according to a first embodiment of the present invention. Referring to FIG. 1, the method of combining intellectual asset 100 provided by the present invention is suitable for accumulating, utilizing, and managing intellectual asset. The intellectual asset is, for example, an intellectual asset combination composed of multiple patent data, or external or internal documents or news in paper or electronic format. The method of combining intellectual asset 100, for example, comprises a process 110 of key word combination, a process 120 of self-determined combination, and a process 130 of recombination. The process 110 of key word combination comprises a step 112, which includes inputting at least one key term (such as “artificial intelligence”) or at least one key word (such as “intelligence”), acquiring at least one key word document from the intellectual asset according to the key term or the key word and a predetermined search condition (such as Boolean logic-And, Or, Not), and repeating step 112 to assemble multiple key word documents into a key word document set.

Referring to FIG. 1, the process 120 of self-determined combination comprises a step 122, which includes inputting a self-determined index, and the self-determined index includes a specific number or data. When the intellectual asset is composed of the patent data, the specific number is, for example, the application number or filing date. The process 120 of self-determined combination also comprises acquiring at least one self-determined index document from the intellectual asset according to the self-determined index and a predetermined search condition (such as Boolean logic-And, Or, Not), and repeating step 122 to assemble multiple self-determined index documents into a self-determined index document set.

Referring to FIG. 1, the process 130 of recombination comprises a step 132, which includes inputting a predetermined search condition, and the predetermined search condition is, for example, Boolean logic such as And, Or, Not, or other symbol (such as patent application number) or text (such as the name of Applicant or Inventor). The process 130 of recombination also comprises reassembling the existing key word document set or the existing self-determined index document set.

Referring to FIG. 1, in the method of combining intellectual asset 100 described in the first embodiment of the present invention, the process 110 of key word combination further comprises the following steps. After the step 112 is performed, or after the user inputs the key term or the key word, the key word document set not matching with a predetermined key word sifting condition (such as Boolean logic-And, Or, Not) is deleted in step 114. Then, in step 116, the remaining key word document set after the deletion is saved in a database, for example.

Referring to FIG. 1, in the method of combining intellectual asset 100 described in the first embodiment of the present invention, the process 120 of self-determined combination further comprises the following steps. After the step 122 is performed, i.e. after the user inputs the self-determined index, the self-determined index document set not matching with a predetermined self-determined sifting condition (such as Boolean logic-And, Or, Not) is deleted in step 124. Then, in step 126, the remaining self-determined index document set after the deletion is saved in a database, for example.

Referring to FIG. 1, in the method of combining intellectual asset 100 described in the first embodiment of the present invention, the process 130 of recombination further comprises the following steps. After the step 132 is performed, i.e. after the existing key word document set or the existing self-determined index document set had been reassembled, the key word document set or the self-determined index document set not matching with a predetermined reassembling sifting condition (such as a Boolean logic-And, Or, Not) is deleted in step 134. And then, in step 136, the remaining key word document set and the remaining self-determined index document set after the deletion are saved in a database, for instance.

The method of combining intellectual asset 100 provided by the present invention combines the process 110 of key word combination, the process 120 of self-determined combination, and the process 130 of recombination. In addition, the intellectual asset combination 10 is acquired by deleting some documents according to the sifting condition, and storing the remaining document set after the deletion. Accordingly, it is possible to effectively accumulate working knowledge and experiences of the employees, and further transfer the intellectual capital into the intellectual asset and to keep accumulating the intellectual asset, such that the enterprise's competitiveness is effectively enhanced.

### Second Embodiment

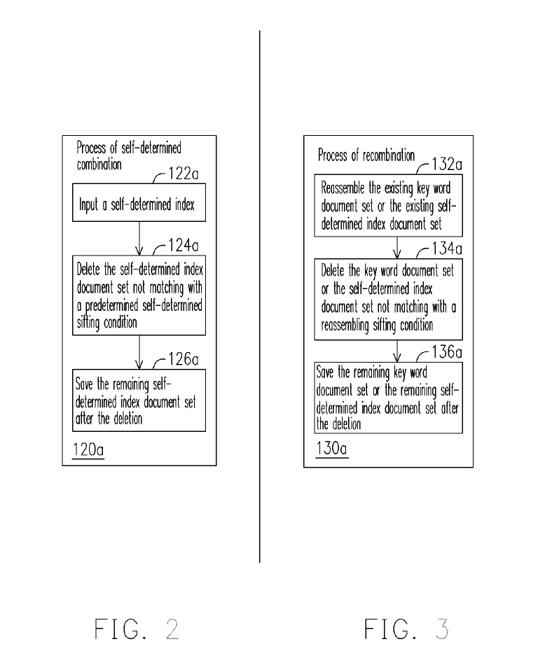

FIG. 2 schematically shows a flow chart illustrating a process of self-determined combination according to a second embodiment of the present invention. Referring to FIG. 2, the process of self-determined combination 120a provided by the present invention comprises a plurality of steps 122b, 124b, and 126b, which are similar to the steps 122, 124, and 126 described in the first embodiment, respectively. In addition, the effect achieved by the process of self-determined combination 120a provided by the present invention is similar to that in the method of combining intellectual asset 100 described in the first embodiment, thus details are not repeated herein.

### Third Embodiment

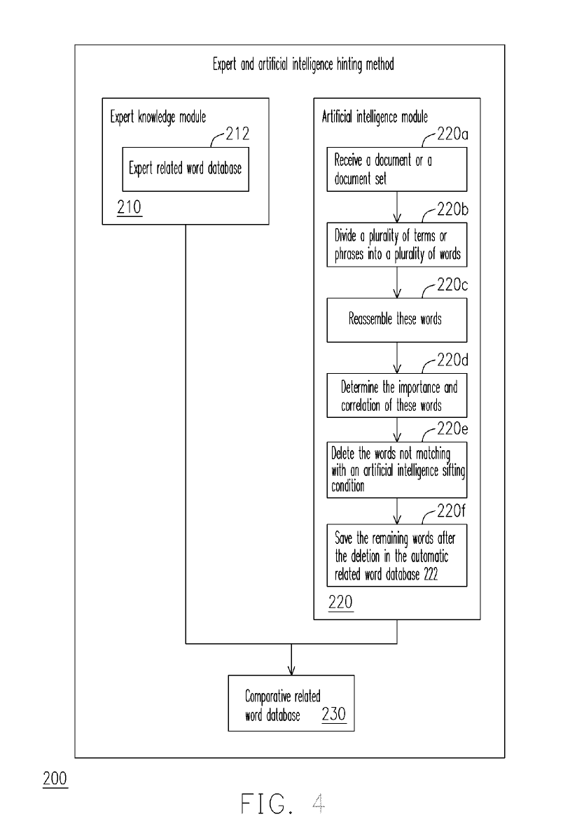

FIG. 3 schematically shows a flow chart illustrating a process of recombination according to a third embodiment of the present invention. Referring to FIG. 3, the process of recombination 130a provided by the present invention comprises a plurality of steps 132b, 134b, and 136b, which are similar to the steps 132, 134, and 136 described in the first embodiment, respectively. In addition, the effect achieved by the process of recombination 130a provided by the present invention is similar to that in the method of combining intellectual asset 100 described in the first embodiment mentioned above, thus its details are not repeated herein.

### Fourth Embodiment

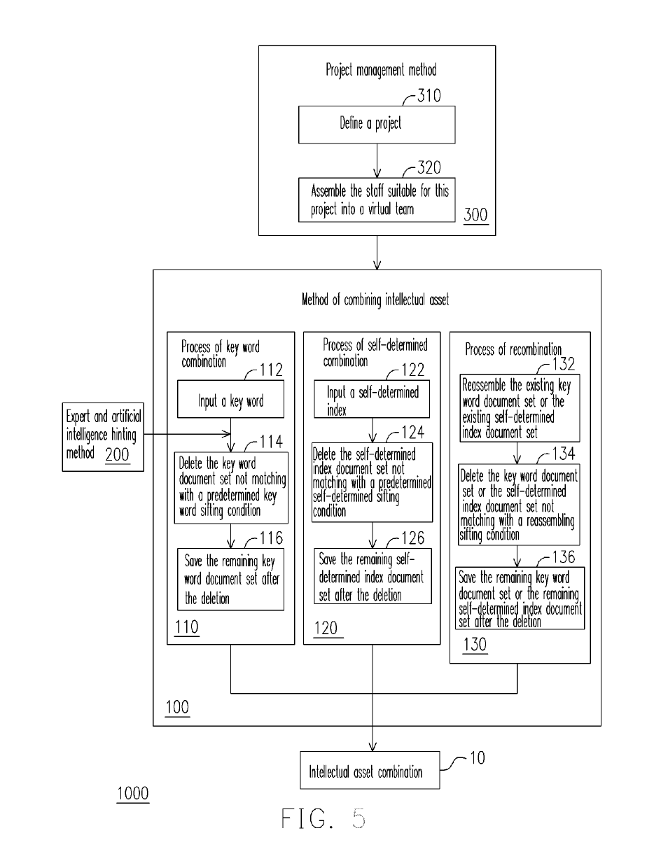

FIG. 4 schematically shows a flow chart illustrating an expert and artificial intelligence hinting method according to a fourth embodiment of the present invention. Referring to both FIG. 1 and FIG. 4, the expert and artificial intelligence hinting method 200 provided by the present invention may be combined with the process 110 of key word combination in the method of combining intellectual asset 100 described in the first embodiment. The expert and artificial intelligence hinting method 200 provided by the present invention comprises the following steps. First, in step 112, the user inputs at least one key word. Then, a word related to the key word is obtained from a comparative word database 230 provided by the expert and artificial intelligence hinting method 200. Afterwards, the related word is provided to the user while selecting the key words/terms, so as to help the user quickly determine the combination of key words/terms, and to prevent the user from missing the potential key words/terms. Accordingly, the efficiency and quality of information search is effectively improved.

Referring to FIG. 4, the expert and artificial intelligence hinting method 200 provided by the present invention further comprises providing an expert knowledge module 210 and an artificial intelligence module 220. Wherein, the expert knowledge module 210 provides an expert related word database 212, and the artificial intelligence module 220 provides an automatic related word database 222. The expert related word database 212 is combined with the automatic related word database 222 to form a comparative related word database 230.

Referring to FIG. 4, in the expert and artificial intelligence hinting method 200 provided by the present invention, the artificial intelligence module 220 performs the following steps. First, in step 220a, a document or a document set is received and saved in a database. Then, in step 220b, a plurality of terms or phrases in the document or the document set are appropriately divided into a plurality of words, and the words are reassembled in step 220c. Then, in step 220d, the importance and correlation of the words are determined, and in step 220e, the words not matching with an artificial intelligence sifting condition are deleted. Finally, in step 220f, the remaining words after the deletion are saved in the automatic related word database 222.

The expert and artificial intelligence hinting method 200 provided by the present invention helps the user select appropriate key words for acquiring the desired data with a shorter period of time, such that the search time can be reduced. Accordingly, the user can spend more time in activities having physical productivity, such that the enterprise's overall productivity is increased and the competitiveness is further enhanced.

### Fifth Embodiment

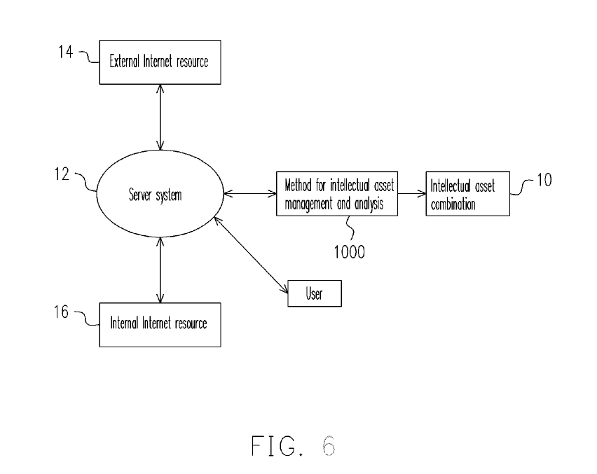

FIG. 5 schematically shows a flow chart illustrating a method for intellectual asset management and analysis according to a fifth embodiment of the present invention. Referring to FIGS. 1, 4, and 5, the method for intellectual asset management and analysis 1000 provided by the present invention is suitable for accumulating, utilizing, and managing intellectual asset. The intellectual asset is, for example, an intellectual asset combination composed of multiple patent data, or internal or external business files or news in the form of electronic or paper format. The method for intellectual asset management and analysis 1000, for example, comprises a method of combining intellectual asset 100 described in the first embodiment and an expert and artificial intelligence 200 hinting method described in the second embodiment. The steps and the modules provided by the method of combining intellectual asset 100 and the expert and artificial intelligence hinting method 200 are clearly described in the first and second embodiments mentioned above respectively, thus its details are not repeated herein.

Referring to FIG. 5, the method for intellectual asset management and analysis 1000 according to the fifth embodiment of the present invention further comprises a project management method 300, which comprises the following steps. First, in step 310, a project is defined by an administrator, such that the projects belonging to different missions and objectives are created. Then, in step 320, the staff required by the project are confirmed by the administrator and assembled into a virtual team. Then, an intellectual asset combination 10 belonging to the project is created by the virtual team according to the method of combining intellectual asset 100. Then, the intellectual asset belonging to the project is analyzed, managed, and utilized by the team members of the project to achieve the collaboration objective of the virtual teams. Accordingly, the working knowledge and experiences of enterprise's employees are effectively accumulated, and the enterprise's intellectual capital is transferred into intellectual asset, such that the competitiveness is effectively enhanced.

In order to demonstrate how the method for intellectual asset management and analysis 1000 in the fifth embodiment is applied, the present invention is further described in great detail with reference to FIG. 6. FIG. 6 schematically shows a system diagram when applying a method for intellectual asset management and analysis 1000 according to the fifth embodiment of the present invention. Referring to FIG. 6, the system applying the method for intellectual asset management and analysis 1000 provided by the present invention comprises a server system 12, an external Internet resource 14, and an internal Internet resource 16. The server system 12 extracts information from the external Internet resource 14 and the internal Internet resource 16. Wherein, the external Internet resource 14, for example, comprises electronic data such as news, patent applications, or other information outside the enterprise. On the other hand, the internal Internet resource 16, for example, comprises electronic data such as news, patent applications, or other information inside the enterprise. When a user inputs at least one key term, key word or other index into the server system 12, an intellectual asset combination 10 is acquired in the system 12 where the method for intellectual asset management and analysis 1000 is applied, such that the enterprise's intellectual capital is transferred into intellectual asset, and the enterprise's competitiveness is effectively enhanced.

It should be noted that the intellectual asset utilized by the method for intellectual asset management and analysis, the method of combining intellectual asset, the expert and artificial intelligence hinting method, the process of self-determined combination, and the process of recombination provided by the present invention, for example, include patents, or other electronic information, data inside or outside the enterprise, or even paper documents, within the scope of the present invention.

In summary, with the method for intellectual asset management and analysis, the method of combining intellectual asset, the process of self-determined combination, and the process of recombination provided by the present invention, some document set is deleted according to the sifting condition, and the remaining document set after the deletion is saved. Accordingly, the working knowledge and experiences of enterprise's employees are effectively accumulated, and the enterprise's intellectual capital is transferred into intellectual asset and can be accumulated, such that the overall competitiveness is effectively enhanced.

In addition, the expert and artificial intelligence hinting method provided by the present invention helps the user select appropriate key word or self-determined index for acquiring the desired data instantly, such that the search time is shortened. Accordingly, the user can spend more time in activities having physical productivity, such that the enterprise's overall productivity is increased and the competitiveness is further enhanced.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. A method for intellectual asset management and analysis suitable for accumulating, utilizing, and managing intellectual asset, and the method comprising:
a method of combining intellectual asset, comprising:
(a) inputting a key word, and acquiring at least one key word document from the intellectual asset according to the key word and a predetermined search condition to form a key word document set;
(b) inputting a self-determined index, and acquiring at least one self-determined index document from the intellectual asset according to the self-determined index to form a self-determined index document set; and
(c) reassembling the existing key word document set and the existing self-determined index document set according to a predetermined sifting condition; and
an expert and artificial intelligence hinting method, comprising:
inputting the key word;
acquiring a word related to the key word from a comparative related word database provided by the expert and artificial intelligence hinting method; and
providing the word for selection.

2. The method for intellectual asset management and analysis of claim 1, wherein the step (a) further comprises:
deleting the key word document set not matching with a predetermined key word sifting condition; and
saving the remaining key word document set after the deletion step.

3. The method for intellectual asset management and analysis of claim 1, wherein the step (b) further comprises:
deleting the self-determined index document set not matching with a predetermined self-determined sifting condition; and
saving the remaining self-determined index document set after the deletion step.

4. The method for intellectual asset management and analysis of claim 1, wherein the step (c) further comprises:
deleting the key word document set or the self-determined index document set not matching with a predetermined reassembling sifting condition; and
saving the remaining key word document set or the remaining self-determined index document set after the deletion step.

5. The method for intellectual asset management and analysis of claim 1, further comprising a project management method, which comprises:
defining a project;
assembling a staff suitable for the project into a virtual team; and
creating an intellectual asset belonging to the project by the virtual team.

6. The method for intellectual asset management and analysis of claim 1, wherein the expert and artificial intelligence hinting method provides an expert knowledge module and an artificial intelligence module, and the expert knowledge module provides an expert related word database, the artificial intelligence module provides an automatic related word database, wherein the expert related word database is combined with the automatic related word database to form a comparative related word database.

7. The method for intellectual asset management and analysis of claim 6, wherein the artificial intelligence module performs the following steps:
receiving a document or a document set;
dividing at least one term or phrase of the document or the document set into a plurality of words;
reassembling the words;
determining an importance and a correlation of the words;
deleting the words not matching with an artificial intelligence sifting condition; and
saving the remaining words after the deletion step into the automatic related word database.

8. The method for intellectual asset management and analysis of claim 1, wherein the intellectual asset comprises patents.

9. A composition method of intellectual asset suitable for accumulating, utilizing, and managing intellectual asset, the method comprising:
(a) inputting a key word, and acquiring at least one key word document from the intellectual asset according to the key word and a predetermined search condition to form a key word document set;
(b) inputting a self-determined index, and acquiring at least one self-determined index document from the intellectual asset according to the self-determined index to form a self-determined index document set; and
(c) reassembling the existing key word document set and the existing self-determined index document set according to a predetermined sifting condition.

10. The composition method of intellectual asset of claim 9, wherein the step (a) further comprises:
deleting the key word document set not matching with a predetermined key word sifting condition; and
saving the remaining key word document set after the deletion step.

11. The method of combining intellectual asset of claim 9, wherein the step (b) further comprises:
deleting the self-determined index document set not matching with a predetermined self-determined sifting condition; and
saving the remaining self-determined index document set after the deletion step.

12. The method of combining intellectual asset of claim 9, wherein the step (c) further comprises:
deleting the key word document set or the self-determined index document set not matching with a predetermined reassembling sifting condition; and
saving the remaining key word document set or the remaining self-determined index document set after the deletion step.

13. The method of combining intellectual asset of claim 9, wherein the intellectual asset comprises patents.

14. A process of self-determined combination, comprising:
inputting a self-determined index, and acquiring at least one self-determined index document from an intellectual asset according to the self-determined index to form a self-determined index document set;
deleting the self-determined index document set not matching with a predetermined self-determined sifting condition; and
saving the remaining self-determined index document set after the deletion step.

15. A process of recombination, comprising:
reassembling a plurality of existing key word document set and a plurality of existing self-determined index document set according to a predetermined sifting condition;
deleting the key word document set or the self-determined index document set not matching with a predetermined reassembling sifting condition; and
saving the remaining key word document set or the remaining self-determined index document set after the deletion step.

16. An expert and artificial intelligence hinting method, comprising:
inputting a key word;
acquiring a word related to the key word from a comparative related word database provided by the expert and artificial intelligence hinting method; and
providing the word for selection.

17. The expert and artificial intelligence hinting method of claim 16, further comprising providing an expert knowledge module and an artificial intelligence module, the expert knowledge module providing an expert related word database, the artificial intelligence module providing an automatic related word database, wherein the expert related word database is combined with the automatic related word database to form a comparative related word database.

18. The expert and artificial intelligence hinting method of claim 1 7, wherein the artificial intelligence module performs the following steps:
receiving a document or a document set;
dividing at least one term or phrase of the document or the document set into a plurality of words;
reassembling the words;
determining an importance and a correlation of the words;
deleting the words not matching with an artificial intelligence sifting condition; and
saving the remaining words after the deletion step into the automatic related word database.
